(19) United States
(12) Patent Application Publication
(10) Pub. No.: US 2026/0342926 A1
(43) Pub. Date: Oct. 29, 2026

(54) DRIVE APPARATUS, SHEET CONVEYING DEVICE, AND IMAGE FORMING APPARATUS

(71) Applicant: Ryoh Ishitsuka, Kanagawa (JP)

(72) Inventor: Ryoh Ishitsuka, Kanagawa (JP)

(73) Assignee: Ricoh Company, Ltd., Tokyo (JP)

(21) Appl. No.: 19/652,014

(22) Filed: Apr. 20, 2026

(30) Foreign Application Priority Data
Apr. 25, 2025 (JP) 2025-073704
Mar. 30, 2026 (JP) 2026-055311

(51) Int. Cl. H04N 1/00

(52) U.S. Cl. CPC H04N 1/00602; H04N 1/0061; H04N 1/00628

(57) ABSTRACT

A drive apparatus includes a first sheet metal, a second sheet metal, and a plurality of gears. The first sheet metal and the second sheet metal face each other. The plurality of gears is disposed between the first sheet metal and the second sheet metal. The second sheet metal includes an opposing surface, an extending portion, and a bent fastening portion. The opposing surface faces the first sheet metal. The extending portion extends from the opposing surface toward the first sheet metal. The bent fastening portion is at a distal end of the extending portion. The bent fastening portion is fastened with a screw to a surface of the first sheet metal. A width dimension of the distal end of the extending portion is shorter than a maximum outer diameter of the screw fastening the bent fastening portion and the first sheet metal.

### CROSS-REFERENCE TO RELATED APPLICATIONS

This patent application is based on and claims priority pursuant to 35 U.S.C. § 119(a) to Japanese Patent Application Nos. 2025-073704, filed on Apr. 25, 2025, and 2026-055311, filed on Mar. 30, 2026, in the Japan Patent Office, the entire disclosure of which is hereby incorporated by reference herein.

### TECHNICAL FIELD

The present disclosure relates to a drive apparatus, a sheet conveying device, and an image forming apparatus.

### RELATED ART

A drive apparatus includes a pair of sheet metals facing each other, a plurality of gears disposed between the pair of sheet metals. Of the pair of sheet metals, one sheet metal includes an extending portion which extends from an opposing surface facing the other sheet metal toward the other sheet metal, and a bent fastening portion which is formed by bending a distal end side of the extending portion and fastened with screws to a plate surface of the other sheet metal.

### SUMMARY

The present disclosure described herein provides a drive apparatus that includes a first sheet metal, a second sheet metal, and a plurality of gears. The first sheet metal and the second sheet metal face each other. The plurality of gears is disposed between the first sheet metal and the second sheet metal. The second sheet metal includes an opposing surface, an extending portion, and a bent fastening portion. The opposing surface faces the first sheet metal. The extending portion extends from the opposing surface toward the first sheet metal. The bent fastening portion is at a distal end of the extending portion. The bent fastening portion is fastened with a screw to a surface of the first sheet metal. A width dimension of the distal end of the extending portion is shorter than a maximum outer diameter of the screw fastening the bent fastening portion and the first sheet metal.

The present disclosure described herein also provides a sheet conveying device that includes a conveyor to convey a sheet and the drive apparatus to drive the conveyor.

The present disclosure described herein also provides an image forming apparatus that includes a rotating body and the drive apparatus to drive the rotating body.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram of an image forming apparatus according to an embodiment;

FIG. 2 is a schematic configuration diagram illustrating an example of an image forming apparatus body of an electrophotographic system;

FIG. 3 is a schematic configuration diagram of a sheet feeding apparatus;

FIG. 4A1, 4A2, 4B1, 4B2, 4C1, and 4C2 are schematic explanatory diagrams of a drive apparatus according to an embodiment;

FIGS. 5A and 5B are schematic configuration diagrams of a second sheet metal according to a comparative example;

FIGS. 6A and 6B are explanatory diagrams illustrating fastening in a case where a bent fastening portion is not bent at 90° with respect to an extending portion;

FIGS. 7A and 7B are explanatory diagrams illustrating a result of examining an inter-shaft distance between a motor shaft and a support shaft;

FIGS. 8A, 8B, and 8C are schematic explanatory diagrams of a drive apparatus according to Modification 1;

FIG. 9A is a diagram illustrating fastening to an upper bent fastening portion, and

FIG. 9B is a diagram illustrating fastening to a lower bent fastening portion, respectively, in Modification 1;

FIGS. 10A, 10B, and 10C are schematic configuration diagrams of a drive apparatus according to Modification 2;

FIGS. 11A, 11B, and 11C are schematic explanatory diagrams of a drive apparatus according to Modification 3; and

FIG. 12 is a schematic configuration diagram of a drive apparatus according to Modification 4.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, one embodiment to which the present disclosure is applied will be described.

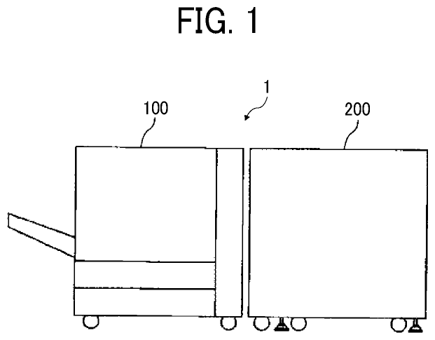

FIG. 1 is a schematic configuration diagram of an image forming apparatus 1 including a sheet feeding apparatus according to the present embodiment.

As illustrated in FIG. 1, the image forming apparatus 1 includes an image forming apparatus body 100 as an image forming unit that forms an image on a sheet 14, and a sheet feeding apparatus 200 as a sheet conveying device that feeds the sheet 14 to the image forming apparatus body 100. The sheet feeding apparatus 200 is disposed on a side surface of the image forming apparatus body 100.

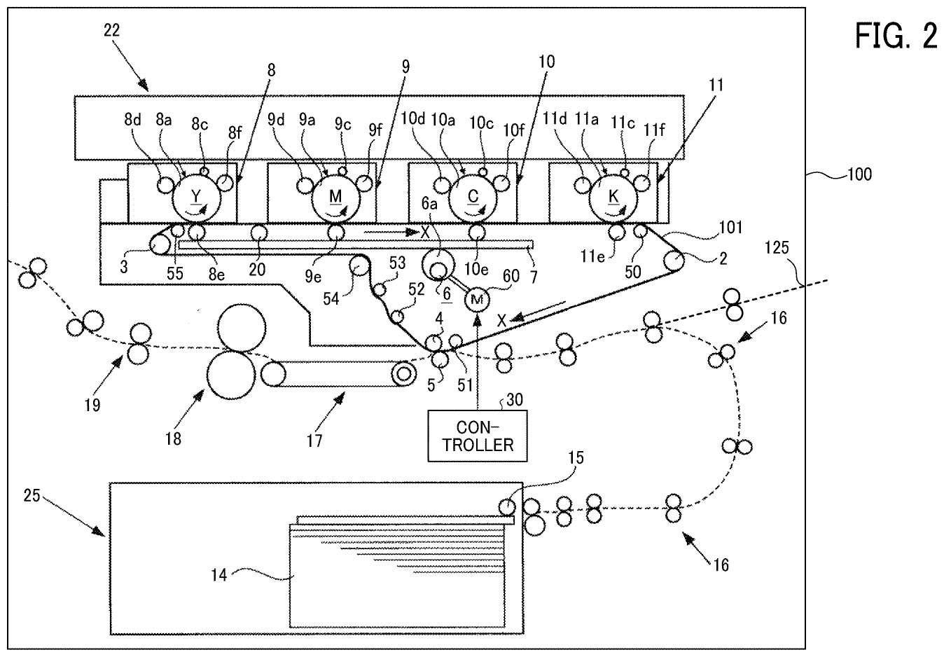

A sheet carry-in portion 125 (see FIG. 2) into which a sheet from the sheet feeding apparatus 200 is carried is disposed on a right side surface of the image forming apparatus body 100 in FIG. 1.

A recording system of the image forming apparatus body 100 is not particularly limited, and any system such as an electrophotographic system or an inkjet system can be adopted. Hereinafter, an overall configuration and an operation of the image forming apparatus body 100 will be described by taking an electrophotographic system as an example of the recording system of the image forming apparatus body 100.

FIG. 2 is a schematic configuration diagram illustrating an example of the image forming apparatus body 100 of the electrophotographic system.

In the image forming apparatus body 100, an intermediate transfer belt 101, which is a belt member that circulates, is stretched with a predetermined tension by a drive roller 2, a driven roller 3, a secondary transfer opposing roller 4, and a plurality of driven rollers 50, 51, 52, 53, 54, and 55.

Further, on the intermediate transfer belt 101, image forming units 8, 9, 10, and 11 corresponding to respective colors of yellow (Y), magenta (M), cyan (C), and black (K) are arranged in this order along a belt traveling direction (an arrow X direction).

The order of these colors is not limited for Y, M, and C. The image forming unit 11 for black is disposed on a most downstream side in the traveling direction of the intermediate transfer belt 101 (a side closer to the drive roller 2).

The image forming units 8, 9, 10, and 11 have photoconductor drums 8a, 9a, 10a, and 11a, respectively, which are photoconductors rotatably supported by a frame of the apparatus body. Around the photoconductor drums 8a, 9a, 10a, and 11a, chargers 8c, 9c, 10c, and 11c, developing devices 8d, 9d, 10d, and 11d, and drum cleaning devices 8f, 9f, 10f, and 11f are arranged in this order along a drum rotation direction (a counterclockwise direction in FIG. 2).

An image writing unit 22 that performs exposure scanning of surfaces of the photoconductor drums 8a, 9a, 10a, and 11a with a laser beam is disposed above the image forming units 8, 9, 10, and 11.

Further, primary transfer rollers 8e, 9e, 10e, and 11e are disposed at positions facing the image forming units 8, 9, 10, and 11 with the intermediate transfer belt 101 interposed therebetween.

Among the plurality of primary transfer rollers 8e, 9e, 10e, and 11e, the primary transfer rollers 8e, 9e, and 10e for colors on an upstream side in the traveling direction of the intermediate transfer belt 101 are held by a bracket 7. The primary transfer rollers 8e, 9e, and 10e for these colors are brought into and out of contact with the photoconductor drums 8a, 9a, and 10a by a contact-separation mechanism 6 including an eccentric cam 6a and a contact-separation drive motor 60. Here, “contact-separation” means displacement or switching between a contact state and a separated state.

Driving of the contact-separation drive motor 60 is controlled by a controller 30 that controls the entire image forming apparatus. Elastic force is applied to the color bracket 7 in a downward direction by a spring or the like. When the eccentric cam 6a of the contact-separation mechanism 6 is rotated to a position illustrated in the drawing by the contact-separation drive motor 60, the color bracket 7 is raised to move the primary transfer rollers 8e, 9e, and 10e to positions where the primary transfer rollers 8e, 9e, and 10e contact the respective photoconductor drums 8a, 9a, and 10a via the intermediate transfer belt 101.

The primary transfer roller 11e for single-color (black) image transfer is not held by the color bracket 7, and the distance between the primary transfer roller 11e and the photoconductor drum 11a does not change.

Further, a position adjusting roller 20 is disposed between the primary transfer rollers 8e and 9e so as to contact a lower surface of the intermediate transfer belt 101. The position adjusting roller 20 adjusts a position of the intermediate transfer belt 101 by moving one end side in an axial direction in a surface moving direction of the intermediate transfer belt 101.

The image forming apparatus body 100 is switchable between a full-color mode for forming a full-color image and a monochrome mode. In a case of the full-color mode, all of the primary transfer rollers 8e, 9e, 10e, and 11e are located at positions where the primary transfer rollers 8e, 9e, 10e, and 11e contact the respective photoconductor drums 8a, 9a, 10a, and 11a via the intermediate transfer belt 101.

In a case of the monochrome mode, the primary transfer rollers 8e, 9e, and 10e are separated from the photoconductor drums 8a, 9a, and 10a by the contact-separation unit described above, and only the primary transfer roller 11e for black image transfer contacts the photoconductor drum 11a via the intermediate transfer belt 101.

Meanwhile, the sheet 14, which is a recording medium to be subjected to image formation, is stored in a sheet feeding cassette 25 and is fed out one by one by a pickup roller 15 disposed on a sheet feeding-out side of the sheet feeding cassette 25. The sheet 14 fed out from the sheet feeding cassette 25 is conveyed by a plurality of conveying roller pairs 16 along a path indicated by a broken line in FIG. 2, and is sent to a secondary transfer position where a secondary transfer roller 5 and the secondary transfer opposing roller 4 face each other with the intermediate transfer belt 101 interposed therebetween.

On a downstream side in a sheet conveying direction from the secondary transfer position, a sheet conveying device 17, a fixing device 18, a discharge conveying roller pair 19, and the like are arranged.

Next, an operation in a case of the full-color mode will be described.

First, an image formation process in each of the image forming units 8, 9, 10, and 11 is started in this order. In the image formation process, first, surfaces of the photoconductor drums 8a, 9a, 10a, and 11a are uniformly charged by the chargers 8c, 9c, 10c, and 11c. Next, the surfaces are exposed in accordance with images of the respective colors by light scanning performed by the image writing unit 22, and electrostatic latent images are formed on the respective surfaces. The formed latent images are developed with toners of the respective colors by the developing devices 8d, 9d, 10d, and 11d, respectively, and yellow, magenta, cyan, and black toner images are sequentially formed.

The toner images on the photoconductor drums 8a, 9a, 10a, and 11a are sequentially superimposed and primarily transferred onto the intermediate transfer belt 101 by an action of the primary transfer rollers 8e, 9e, 10e, and 11e to which a bias voltage is applied, and a full-color image of yellow, magenta, cyan, and black is formed on the intermediate transfer belt 101.

Thereafter, the color image is sent to the secondary transfer position as the intermediate transfer belt 101 travels. Further, conveyed at a predetermined timing, the sheet 14 fed out from the sheet feeding cassette 25, or the sheet 14 of the sheet feeding apparatus 200 carried in from the sheet carry-in portion 125 on a right side surface of the image forming apparatus body 100, is sent to the secondary transfer position. Then, by an action of the secondary transfer roller 5 to which a bias voltage is applied, the color image on the intermediate transfer belt 101 is collectively transferred (secondary transfer) onto the sheet 14.

The sheet 14 onto which the color image has been transferred is conveyed to the fixing device 18 by the sheet conveying device 17, is subjected there to a fixing process by heating and pressurization, and is then discharged to a discharge tray by a plurality of discharge conveying roller pairs 19.

Examples of the sheet 14 include paper, coated paper, label paper, an overhead projector (OHP) sheet, film, prepreg, and the like. Prepreg is mainly used as a material for a laminate and a multilayer printed wiring board. Prepreg is, for example, processed into a sheet material by continuously impregnating a long base material such as glass cloth, paper, nonwoven fabric, or aramid cloth with a resin varnish mainly containing a thermosetting resin such as an epoxy resin or a polyimide resin, heating and drying the long base material, and then cutting the long base material.

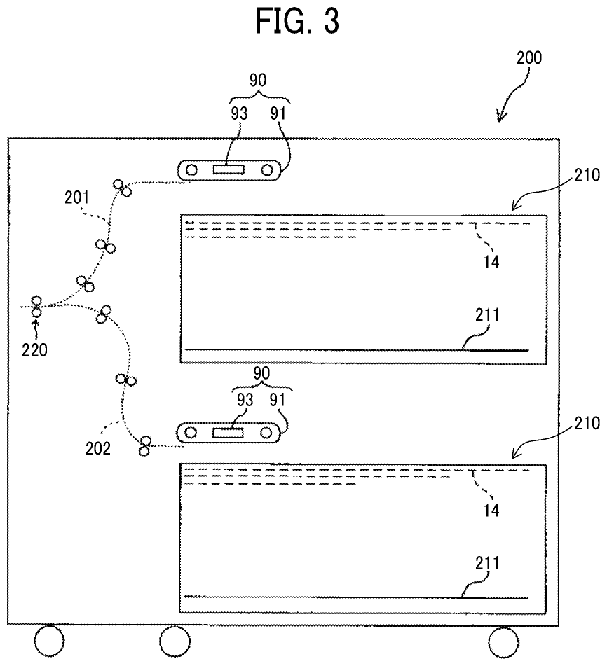

FIG. 3 is a schematic configuration diagram of the sheet feeding apparatus 200.

As illustrated in FIG. 3, the sheet feeding apparatus 200 includes two storage trays 210 arranged in upper and lower stages. Each of the storage trays 210 includes a sheet stacking table 211 as a sheet stacking portion on which a sheet bundle is stacked. Each of the storage trays 210 can store, for example, up to about 2,500 sheets 14.

Above each of the storage trays 210, a feeding unit 90 that separates and feeds the sheets 14 stacked on the storage tray 210 is disposed. The feeding unit 90 includes a suction belt 91 and a suction device 93 as a conveying unit.

The sheets 14 stacked on the lower storage tray 210 are conveyed to the image forming apparatus body 100 through a lower conveyance path 202 by an exit roller pair 220. The sheets 14 stacked on the upper storage tray 210 are conveyed to the image forming apparatus body 100 through an upper conveyance path 201 by the exit roller pair 220.

Next, a drive apparatus used in the image forming apparatus 1, which is a characteristic portion of the present embodiment, will be described.

The drive apparatus described below is applicable to a drive apparatus that drives the suction belt 91 of the sheet feeding apparatus 200, a drive apparatus that drives the exit roller pair 220, and a drive apparatus that drives a conveying roller pair of the upper conveyance path 201 and a conveying roller pair of the lower conveyance path 202.

Further, the drive apparatus described below is also applicable to a drive apparatus that drives rotating bodies such as the drive roller 2 of the intermediate transfer belt 101 of the image forming apparatus body 100, a photoconductor drum, the pickup roller 15, the conveying roller pair 16, the sheet conveying device 17, and the discharge conveying roller pair 19.

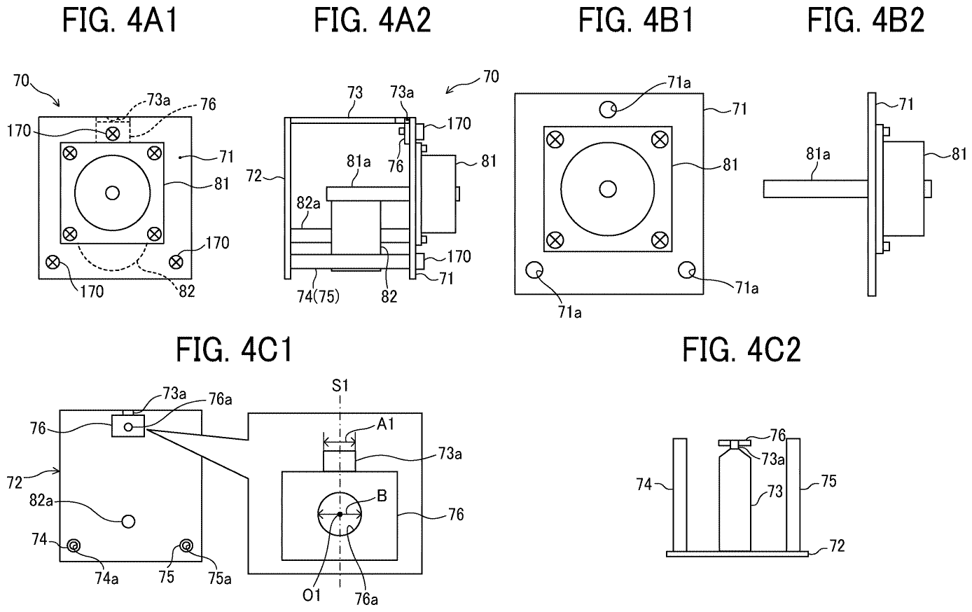

FIG. 4A1, 4A2, 4B1, 4B2, 4C1, and 4C2 are schematic explanatory diagrams of a drive apparatus 70 of the present embodiment.

FIG. 4A1 and 4A2 are schematic configuration diagrams of the drive apparatus 70. FIG. 4A1 is a front view of the drive apparatus 70, and FIG. 4A2 is a side view of the drive apparatus 70. FIG. 4B1 and 4B2 are schematic configuration diagrams of a first sheet metal 71 as the other sheet metal. FIG. 4B1 is a front view of the first sheet metal 71, and FIG. 4B2 is a side view of the first sheet metal 71. FIG. 4C1 and 4C2 are schematic configuration diagrams of a second sheet metal 72 as one sheet metal. FIG. 4C1 is a front view of the second sheet metal 72, and FIG. 4C2 is a plan view of the second sheet metal 72.

As illustrated in FIG. 4B1 and 4B2, a motor 81 is fastened to the first sheet metal 71 with screws, and a motor shaft of the motor 81 as a rotary shaft passes through the first sheet metal 71, and a motor gear 81a directly formed on or molded with the motor shaft is disposed between the first sheet metal 71 and the second sheet metal 72. The first sheet metal 71 holds the motor gear 81a as a gear via the motor 81. Further, in the first sheet metal 71, screw insertion holes 71a into which screws 170 for fastening the sheet metals to each other are inserted are disposed at three locations.

As illustrated in FIG. 4C1 and 4C2, the second sheet metal 72 is provided with a support shaft 82a as a fixed shaft that rotatably supports a gear 82 that meshes with the motor gear 81a. Further, as illustrated in FIG. 4C1, fastening shafts 74 and 75, which are shafts and fastening portions for fastening to the first sheet metal 71, are disposed on both left and right sides in the drawing on a lower side of the second sheet metal 72. Female threads 74a and 75a are disposed at distal ends of the fastening shafts 74 and 75.

Further, the second sheet metal 72 is provided with a bent fastening portion 76 formed by bending the sheet metal. As illustrated in FIG. 4C1, the bent fastening portion 76 is formed by bending a distal end side of an extending portion 73 at 90°, the extending portion 73 being bent at 90° from a center in a left-right direction in the drawing on an upper portion of the second sheet metal 72 toward the first sheet metal 71 and extended toward the first sheet metal 71, and is parallel to a plate surface as an opposing surface of the second sheet metal 72 and a plate surface of the first sheet metal 71. A female thread 76a is formed at a center of the bent fastening portion 76. The bent fastening portion 76 has a rectangular shape and has a line-symmetrical shape with respect to a reference line S passing through a center O1 of the female thread 76a. Accordingly, a difference in fastening force of screws applied to one end side and the other end side of the bent fastening portion 76 can be reduced, and the bent fastening portion 76 can be brought into favorable close contact with the first sheet metal 71.

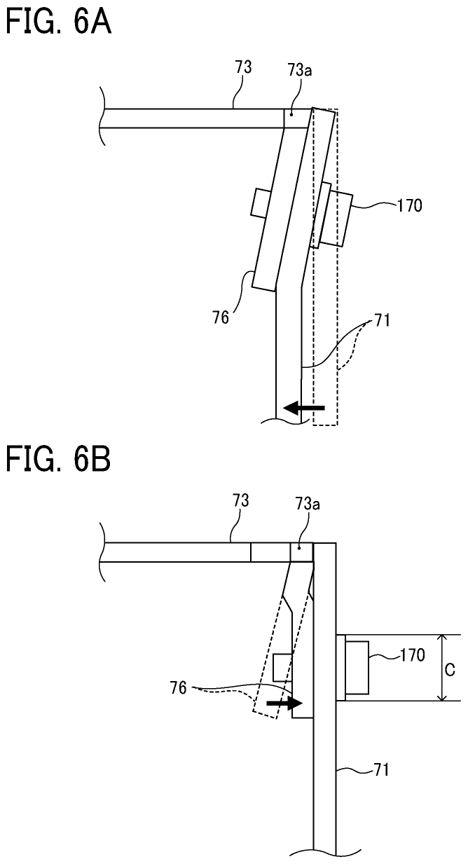

A distal end side of the extending portion 73 is formed such that a width thereof becomes narrower toward a distal end, and a width dimension A1 of a distal end 73a of the extending portion 73 (which is also a bending base of the bent fastening portion 76) is shorter than a diameter B of the female thread 76a. Therefore, in the present embodiment, the width dimension A1 of the distal end 73a is shorter than a maximum outer diameter C (see FIG. 6B) of the screws 170 screwed into the female thread 76a.

As illustrated in FIG. 4, the screws 170 are inserted into the three screw insertion holes 71a of the first sheet metal 71, and the screws 170 are screwed into the female threads 74a, 75a, and 76a of the fastening shafts 74 and 75 and the bent fastening portion 76 of the second sheet metal 72, thereby fastening the first sheet metal 71 and the second sheet metal 72 to each other.

A distance in a vertical direction of the second sheet metal 72 from the second sheet metal 72 to the distal ends of the fastening shafts 74 and 75 and a distance in the vertical direction from the second sheet metal 72 to the bent fastening portion 76 are the same. Accordingly, when the first sheet metal 71 is fastened to the second sheet metal 72 with the screws 170, the first sheet metal 71 is secured in a posture parallel to the second sheet metal 72.

In the present embodiment, as illustrated in FIG. 4A1, a lower end side is fastened at both sides in a left-right direction in the drawing, and an upper end side is fastened at a center in the left-right direction in the drawing, thereby securing the sheet metals to each other at three points. By securing at three points in this manner, a posture of the sheet metals is stabilized, and the first sheet metal 71 can be favorably maintained in a posture parallel to the second sheet metal 72. Although the posture of the sheet metals is also stabilized by securing at four points, an increase in the number of fastening portions tends to cause variations in a height of the fastening portions from the second sheet metal 72 due to a dimensional error, and a risk that the first sheet metal 71 is deformed when the first sheet metal 71 is fastened to the respective fastening portions of the second sheet metal 72 increases.

As in the present embodiment, by providing three fastening portions including two fastening shafts 74 and 75 and the bent fastening portion 76, and fastening the first sheet metal 71 to the second sheet metal 72 at three points, the risk of deformation of the first sheet metal due to a dimensional error of the fastening portions can be reduced.

Further, in the present embodiment, of the three fastening portions, at least one is the bent fastening portion 76 formed by bending the sheet metal. The fastening shafts 74 and 75 are members separate from the second sheet metal 72, and the fastening shafts 74 and 75 are generally secured to the sheet metal by a caulking process. The caulking process includes a process of forming holes in the sheet metal, a process of press-fitting the fastening shafts 74 and 75 into the holes, and a process of crushing a portion of the fastening shafts 74 and 75 where the holes have passed through, and therefore involves many man-hours. On the other hand, the bent fastening portion 76 can be formed by a process of bending the sheet metal twice, and the fastening portions can be formed with fewer man-hours than in the case of the fastening shafts 74 and 75. Therefore, by using, as at least one of the three fastening portions, the bent fastening portion 76 formed by bending the sheet metal, manufacturing cost can be reduced.

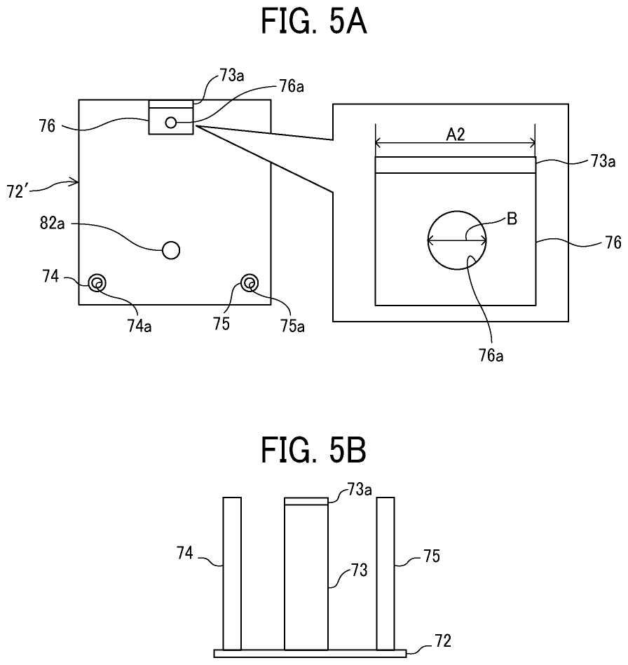

FIGS. 5A and 5B are schematic configuration diagrams of a second sheet metal 72′ of a comparative example.

In the second sheet metal 72′ of the comparative example, a width dimension A2 of the distal end 73a of the extending portion 73 is the same as a width dimension of the extending portion 73 and is longer than a maximum outer diameter C (see FIG. 6B) of the screws 170 screwed into the female thread 76a of the bent fastening portion 76. In this manner, in the comparative example, the width dimension of the distal end 73a is increased.

FIGS. 6A and 6B are explanatory diagrams illustrating fastening in a case where the bent fastening portion 76 is not at 90° with respect to the extending portion 73 due to a manufacturing error. FIG. 6A illustrates a periphery of the bent fastening portion of the second sheet metal of the comparative example illustrated in FIGS. 5A and 5B, and FIG. 6B illustrates a periphery of the bent fastening portion of the second sheet metal 72 of the present embodiment.

As the screws 170 are screwed into the female thread 76a of the bent fastening portion 76, due to tightening of the screws 170, the first sheet metal 71 receives a force toward the bent fastening portion, and the bent fastening portion 76 receives a force toward the first sheet metal.

As described with reference to FIGS. 5A and 5B, in the comparative example, the width dimension A2 of the distal end 73a of the extending portion 73 of the second sheet metal 72 is the same as a width dimension of the extending portion 73 and is longer than the maximum outer diameter C of the screws 170 screwed into the female thread 76a of the bent fastening portion 76. Therefore, rigidity of the distal end 73a is high, and the bent fastening portion 76 is less likely to be bent with respect to the extending portion 73. Accordingly, as illustrated in FIG. 6A, when the screws 170 are tightened, the first sheet metal 71 is deformed following the bent fastening portion 76.

On the other hand, in the present embodiment, as illustrated in FIG. 4C1, the width dimension A1 of the distal end 73a is shorter than the maximum outer diameter C of the screws 170 screwed into the female thread 76a of the bent fastening portion 76. Therefore, rigidity of the distal end 73a is low, and the bent fastening portion 76 is more likely to be bent with respect to the extending portion 73. Accordingly, as illustrated in FIG. 6A, when the screws 170 are tightened, the bent fastening portion 76 is deformed following the first sheet metal 71, and deformation of the first sheet metal 71 is suppressed.

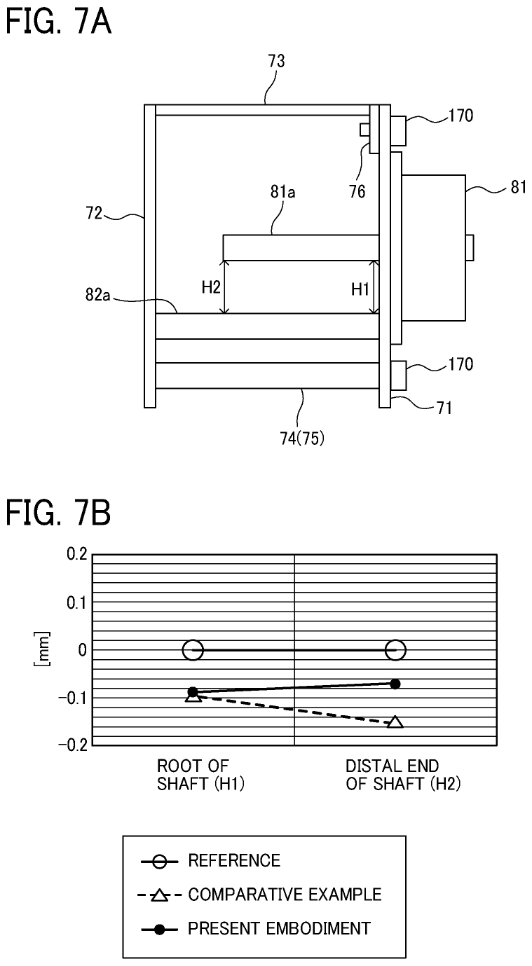

FIGS. 7A and 7B are diagrams illustrating results of examining, in the comparative example and the present embodiment, an inter-shaft distance (H1) between a root side of the motor shaft and a root side of the support shaft 82a and an inter-shaft distance (H2) between a distal end of the motor shaft and a distal end of the support shaft 82a.

As illustrated in FIG. 7B, regarding the inter-shaft distance H1 on the root side, in both the comparative example and the present embodiment, the inter-shaft distance H1 has been narrowed to a similar extent with respect to a reference dimension. On the other hand, regarding the inter-shaft distance H2 at the distal end, it can be seen that, in the present embodiment, narrowing between the shafts with respect to the reference dimension is reduced as compared with the comparative example.

This is because, in the comparative example, as illustrated in FIG. 6A, the first sheet metal 71 is deformed by fastening to the bent fastening portion 76, and thus the motor 81 attached to the first sheet metal 71 is inclined with respect to an up-down direction and the motor shaft is inclined with respect to the support shaft 82a that is substantially parallel to a horizontal direction. As a result, the inter-shaft distance H2 at the distal end is significantly narrowed.

On the other hand, in the present embodiment, as illustrated in FIG. 6B, deformation of the first sheet metal 71 is suppressed. Therefore, inclination of the motor 81 attached to the first sheet metal 71 with respect to the up-down direction is suppressed. Accordingly, inclination of the motor shaft with respect to the support shaft 82a is suppressed, and narrowing of the inter-shaft distance H2 at the distal end is suppressed.

In the comparative example, the motor shaft is inclined with respect to the support shaft 82a. Therefore, meshing between the motor gear 81a (the gear held by the first sheet metal 71) directly formed on or molded with the motor shaft and the gear 82 (the gear held by the second sheet metal 72) supported by the support shaft 82a is degraded. As a result, an increase in noise, a decrease in transmission accuracy, breakage of a gear tooth, or the like may occur.

On the other hand, in the present embodiment, inclination of the motor shaft with respect to the support shaft 82a is suppressed, and the motor gear 81a (the gear held by the first sheet metal 71) and the gear 82 (the gear held by the second sheet metal 72) supported by the support shaft 82a can be meshed with each other favorably, degradation of noise and transmission accuracy can be suppressed, and breakage of a gear can also be suppressed.

Next, modifications will be described.

### Modification 1

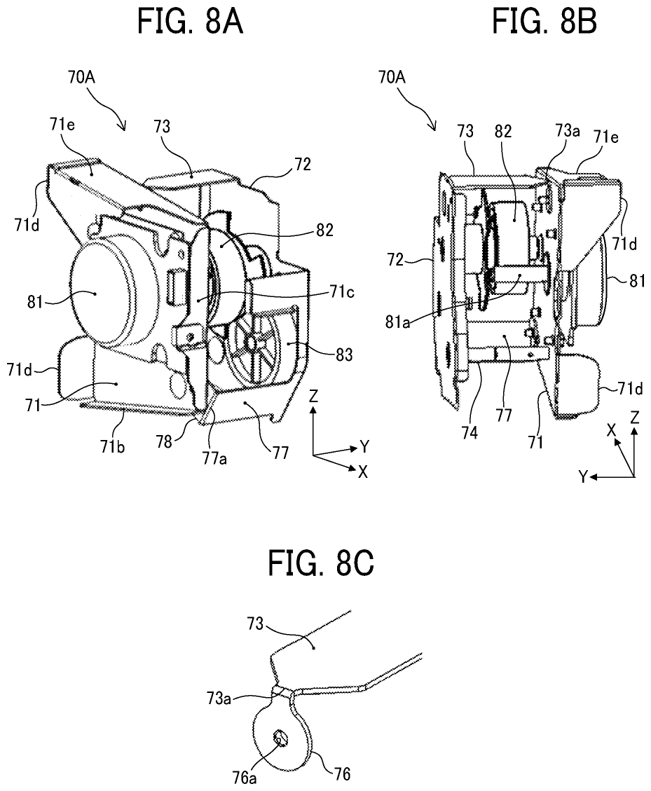

FIGS. 8A, 8B, and 8C are schematic explanatory diagrams of a drive apparatus 70A of Modification 1.

As illustrated in FIGS. 8A, 8B, and 8C, in Modification 1, of the three fastening portions, two are the bent fastening portion 76 and a bent fastening portion 78, and one is the fastening shaft 74. Accordingly, as compared with the above-described embodiment, manufacturing man-hours can be further reduced, and manufacturing cost can be further reduced. Note that all of the three fastening portions may be bent fastening portions. Further, in the drive apparatus 70 of Modification 1, the second sheet metal 72 rotatably holds the gear 82 and a gear 83.

In Modification 1, of the two bent fastening portions 76 and 78, the bent fastening portion 76 (hereinafter referred to as upper bent fastening portion) that fastens an upper portion of the first sheet metal 71 has a substantially circular shape. Further, as illustrated in FIG. 8C, the distal end 73a of the upper extending portion 73 in which the upper bent fastening portion 76 is formed on the distal end side is formed such that the width dimension thereof is shorter than the maximum outer diameter of the screws screwed into the female thread 76a of the upper bent fastening portion 76.

On the other hand, a width dimension of a distal end 77a of a lower extending portion 77 in which the bent fastening portion 78 (hereinafter referred to as lower bent fastening portion) that fastens a lower corner of the first sheet metal 71 is formed on the distal end side is the same as a width dimension of the lower extending portion 77 and is longer than the maximum outer diameter of the screws.

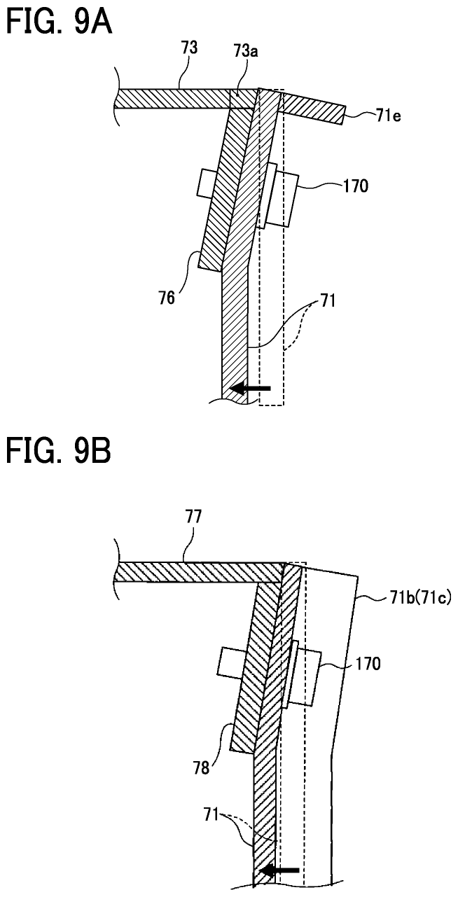

In Modification 1, an edge of the first sheet metal 71 is bent to form edge bent portions 71b, 71c, 71d, and 71e. In the vicinity of a location that is fastened to the lower bent fastening portion 78 of the first sheet metal 71, as illustrated in FIG. 8A, there are the edge bent portions 71b and 71c. In order for the first sheet metal 71 to be deformed following the lower bent fastening portion 78 when the first sheet metal 71 is fastened to the lower bent fastening portion 78, as illustrated in FIG. 9B, the edge bent portions 71b and 71c are to be bend-deformed. Therefore, the edge bent portions 71b and 71c serve as reinforcement. Accordingly, regarding the width dimension of the distal end 77a of the lower extending portion 77, even without shortening the width dimension to be shorter than the maximum outer diameter of the screws 170 fastening the lower bent fastening portion 78 and the first sheet metal 71 to weaken strength of the distal end 77a, at the time of fastening, the lower bent fastening portion 78 is deformed following the first sheet metal 71. As a result, in Modification 1, the distal end 77a of the lower extending portion 77 has the same width dimension as the lower extending portion 77 and the lower bent fastening portion 78, thereby reducing manufacturing cost.

In the vicinity of a location that is fastened to the upper bent fastening portion 76 of the first sheet metal 71, as illustrated in FIG. 8A, there is the edge bent portion 71e. When the first sheet metal 71 is fastened to the upper bent fastening portion 76, as illustrated in FIG. 9A, without the edge bent portion 71e being deformed, the first sheet metal 71 is deformed following the upper bent fastening portion 76. Accordingly, the edge bent portion 71e does not serve as reinforcement of the first sheet metal against the fastening force. Therefore, when the distal end 73a of the upper extending portion 73 has the same width dimension as the upper extending portion 73, the first sheet metal 71 is deformed following the bent fastening portion 76 at the time of fastening. Accordingly, the width dimension of the distal end 73a of the upper extending portion 73 is made shorter than the maximum outer diameter of the screws fastening the first sheet metal 71 to the upper bent fastening portion 76, thereby reducing strength of the distal end 73a. Accordingly, at the time of fastening, the upper bent fastening portion 76 is deformed following the first sheet metal 71, and deformation of the first sheet metal 71 is suppressed.

As described above, in a case where the sheet metals are fastened to each other at three points, in order to stably secure a posture of the sheet metals, of the three fastening portions, two fastening portions are disposed at corners of the sheet metals, the corners being on both sides of one end side, and one fastening portion is disposed at a center of the other end side of the sheet metal. In fastening to the fastening portions disposed at the corners of the sheet metal on the one end side, at least one of the edge bent portion extending in the up-down direction in the vicinity of the fastening portion and the edge bent portion extending in the left-right direction in the vicinity of the fastening portion acts as reinforcement against the fastening force, as illustrated with reference to FIG. 9B. On the other hand, in fastening to the fastening portion at the center on the other end side of the sheet metal, the edge bent portion extending in the left-right direction in the vicinity of the fastening portion does not serve as reinforcement against the fastening force. Accordingly, in a case where the fastening portion at the center on the other end side of the sheet metal is the bent fastening portion, it is preferable that the width dimension of the distal end of the extending portion is shorter than the maximum outer diameter of the screws.

### Modification 2

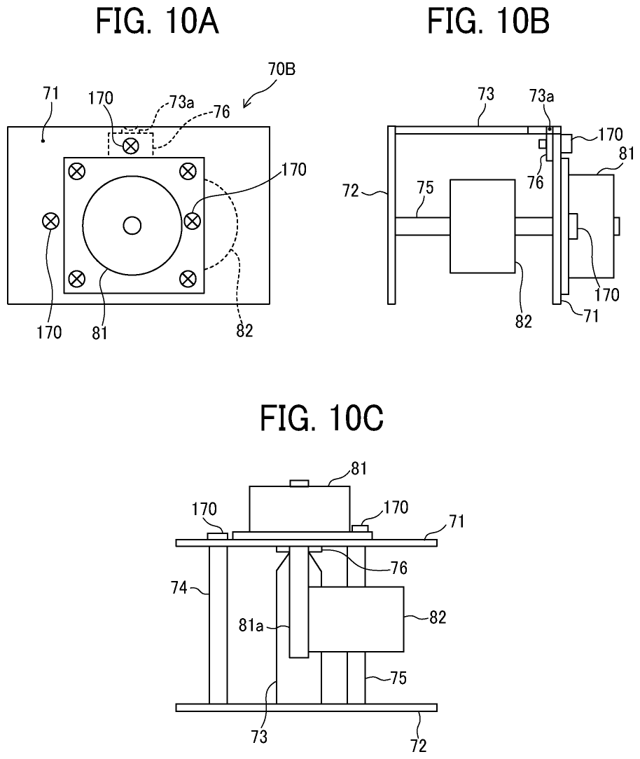

FIGS. 10A, 10B, and 10C are schematic configuration diagrams of a drive apparatus 70B of Modification 2.

In the drive apparatus 70B of Modification 2, the fastening shaft 75 is used as a support shaft (a fixed shaft) that rotatably supports the gear 82. By using the fastening shaft 75 as the support shaft, the number of components can be reduced, and cost reduction of the apparatus can be achieved.

Modification 3

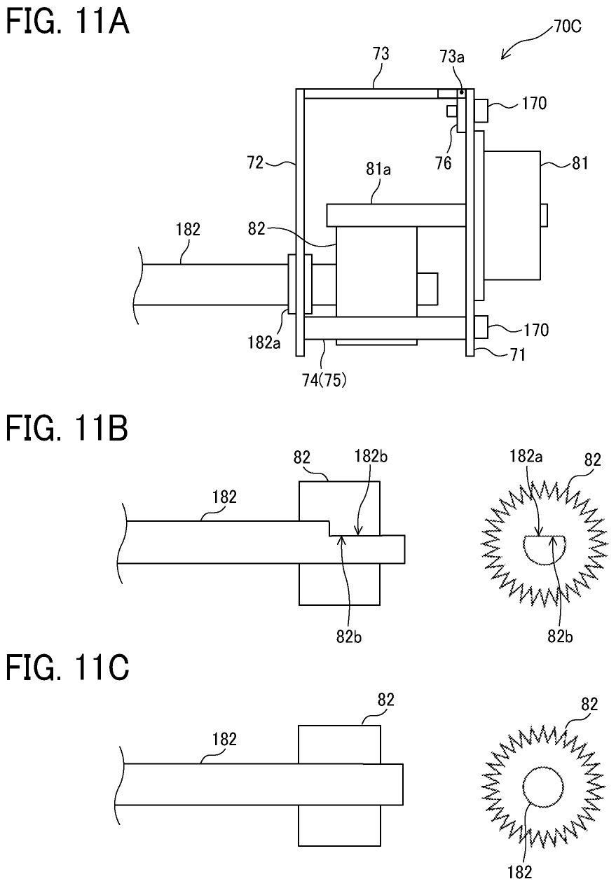

FIGS. 11A, 11B, and 11C are schematic explanatory diagrams of a drive apparatus 70C of Modification 3.

As illustrated in FIG. 11A, in the drive apparatus 70C of Modification 3, the second sheet metal 72 supports a rotary shaft 182 via a bearing 182a. The gear 82 that meshes with the motor gear 81a is disposed at one end of the rotary shaft 182.

The gear 82 is attached to the rotary shaft 182 so as to rotate integrally with the rotary shaft 182. For example, as illustrated in FIG. 11B, by providing a D-cut shaped portion 182b at one end of the rotary shaft 182 and providing a shaft insertion portion 82b having a D-cut cross-sectional shape in the gear 82, the gear 82 can be attached to the rotary shaft 182 so as to rotate integrally with the rotary shaft 182. Further, as illustrated in FIG. 11C, the gear 82 may be press-fitted into one end of the rotary shaft 182 to attach the gear 82 to the rotary shaft 182 so as to rotate integrally with the rotary shaft 182. Further, the gear 82 may be directly formed or molded with at one end of the rotary shaft 182.

### Modification 4

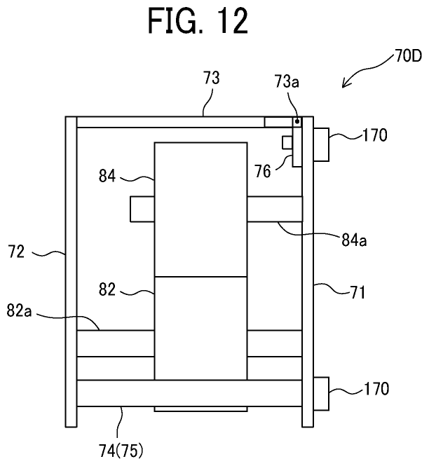

FIG. 12 is a schematic configuration diagram of a drive apparatus 70D of Modification 4.

In Modification 4, a gear 84 that meshes with the gear 82 rotatably supported by the second sheet metal 72 is rotatably supported on a support shaft 84a as a fixed shaft secured to the first sheet metal 71.

Also in Modification 4, by making the width dimension of the distal end 73a of the extending portion 73 in which the bent fastening portion 76 is formed shorter than the maximum outer diameter of the screws 170, at the time of fastening, the bent fastening portion 76 is deformed to follow the first sheet metal 71, and deformation of the first sheet metal 71 can be suppressed. Therefore, inclination of the support shaft 84a of the first sheet metal 71 with respect to the support shaft 82a of the second sheet metal 72 can be suppressed, and degradation of meshing between the gear 82 held by the second sheet metal 72 and the gear 84 held by the first sheet metal 71 can be suppressed.

Although some embodiments of the present disclosure have been described above, the present disclosure is not limited to the above-described embodiments in particular, and various modifications and changes can be made within the scope of the gist of the present disclosure recited in claims unless otherwise limited in the above description.

For example, in the above description, the bent fastening portion and the fastening shaft are disposed on the second sheet metal 72; however, the bent fastening portion and the fastening shaft may be disposed on the first sheet metal 71. Further, the drive apparatus of the present disclosure is not limited to a drive apparatus that drives the rotating bodies of the sheet feeding apparatus 200 illustrated in FIG. 3 and the rotating bodies of the image forming apparatus body 100 illustrated in FIG. 2, and the present disclosure can also be applied to, for example, a drive apparatus that drives a sheet conveying roller of an automatic document feeder (ADF) or a post-processing apparatus.

The embodiments described above are simply examples. The present disclosure has, for example, the following aspects.

### Aspect 1

According to Aspect 1, the drive apparatus 70 includes the pair of sheet metals 71 and 72 facing each other, and the plurality of gears 81a and 82 disposed between the pair of sheet metals. Of the pair of sheet metals, one sheet metal such as the second sheet metal 72 includes the extending portion 73 extending from an opposing surface facing the other sheet metal such as the first sheet metal 71 toward the other sheet metal, and the bent fastening portion 76 formed by bending the distal end side of the extending portion 73 and fastened with the screws to a plate surface of the other sheet metal, and the width dimension A1 of the distal end 73a of the extending portion 73 is shorter than the maximum outer diameter C of the screws 170 fastening the bent fastening portion 76 and the other sheet metal.

In Aspect 1, the width dimension A1 of the distal end 73a of the extending portion 73 is made shorter than the maximum outer diameter C of the screws 170 fastening the bent fastening portion 76 and the other sheet metal such as the first sheet metal 71, thereby reducing strength of the distal end 73a. Accordingly, the bent fastening portion 76 is more likely to change its posture (be deformed) with the distal end 73a as a base point. Therefore, when the other sheet metal and the bent fastening portion 76 are fastened with the screws 170 in a state where the bent fastening portion 76 is inclined with respect to the other sheet metal due to a processing error or the like, the bent fastening portion 76 is deformed following the other sheet metal, and deformation of the other sheet metal can be suppressed. Accordingly, degradation of meshing between the gears can be suppressed.

### Aspect 2

According to Aspect 2, in the drive apparatus 70 of Aspect 1, one of the plurality of gears is held by the one sheet metal such as the second sheet metal 72, and another gear such as the motor gear 81a that meshes with the gear 82 held by the one sheet metal is held by the other sheet metal such as the first sheet metal 71.

Accordingly, inclination of the gear such as the motor gear 81a held by the other sheet metal such as the first sheet metal 71 can be suppressed, and degradation of meshing with the gear 82 held by the one sheet metal can be suppressed.

### Aspect 3

According to Aspect 3, in the drive apparatus 70 of Aspect 1 or Aspect 2, at least one of the plurality of gears is disposed on a rotary shaft (such as the rotary shaft 182 or the motor shaft) rotatably held by either one of the pair of sheet metals.

Accordingly, degradation of meshing between a gear (such as the motor gear 81a or the gear 82 in FIGS. 11A, 11B, and 11C) disposed on the rotary shaft 182 and another gear meshing with the gear can be suppressed.

### Aspect 4

According to Aspect 4, in the drive apparatus 70 of Aspect 3, the rotary shaft is the motor shaft of the motor 81.

Accordingly, degradation of meshing between the motor gear 81a disposed on the motor shaft and a gear meshing with the motor gear 81a can be suppressed.

### Aspect 5

According to Aspect 5, in the drive apparatus 70 of Aspect 3 or Aspect 4, a gear of the rotary shaft (such as the motor gear 81a or the configuration illustrated in FIG. 11B) is non-removable form the rotary shaft or is or molded with the rotary shaft.

Accordingly, the gear can be rotated integrally with the rotary shaft.

### Aspect 6

According to Aspect 6, in the drive apparatus 70 of any one of Aspects 1 to 5, at least one of the plurality of gears is rotatably supported on a fixed shaft (such as the support shaft 82a illustrated in FIG. 4A1, 4A2, 4B1, 4B2, 4C1, and 4C2, etc., or the support shaft 84a illustrated in FIG. 12) that is non-rotatably held by either one of the pair of sheet metals.

Accordingly, degradation of meshing between the gear supported on the fixed shaft and another gear meshing with the gear can be suppressed.

### Aspect 7

According to Aspect 7, the drive apparatus 70 of any one of Aspects 1 to 6 includes three fastening portions, including the bent fastening portion, that fasten the pair of sheet metals.

Accordingly, as described in the above-described embodiment, as compared with a case where the number of fastening portions is less than three, a posture of the sheet metals can be stabilized. Further, as compared with a case where the number of fastening portions is four or more, it is possible to suppress occurrence of deformation of the sheet metals at the time of fastening due to a dimensional error of the fastening portions.

### Aspect 8

According to Aspect 8, the drive apparatus 70 of any one of Aspects 1 to 7 includes a plurality of fastening portions, including the bent fastening portion, that fasten the pair of sheet metals, and at least one of the plurality of fastening portions is a shaft such as the fastening shaft 74 or 75 in which the female thread 74a or 75a is formed at a distal end of the shaft.

Accordingly, the shaft such as the fastening shaft 74 or 75 is smaller than the bent fastening portion formed by bending the sheet metal. Accordingly, at least one of the plurality of fastening portions is formed as the shaft such as the fastening shaft 74 or 75 having the female thread formed at the distal end of the shaft, thereby increasing a degree of freedom in layout of the plurality of gears disposed between the pair of sheet metals.

### Aspect 9

According to Aspect 9, in the drive apparatus 70 of Aspect 8, the shaft such as the fastening shaft 74 or 75 rotatably supports the gear.

Accordingly, as described in Modification 2, the number of components can be reduced, and cost reduction of the drive apparatus can be achieved.

### Aspect 10

According to Aspect 10, in the drive apparatus 70 of any one of Aspects 1 to 9, the bent fastening portion 76 has a line-symmetrical shape with respect to the reference line S passing through the center of the female thread 76a.

Accordingly, as described in the above-described embodiment, a difference in fastening force of the screws applied to one end side and the other end side of the bent fastening portion 76 can be reduced, and the bent fastening portion 76 can be brought into close contact with the other sheet metal favorably.

### Aspect 11

According to Aspect 11, in the drive apparatus 70 of any one of Aspects 1 to 10, at least one of the pair of sheet metals holds a plurality of gears.

Accordingly, as illustrated in Modification 1, in the case where at least one of the pair of sheet metals holds a plurality of gears, degradation of meshing between the gears can be suppressed.

### Aspect 12

According to Aspect 12, in the drive apparatus 70 of any one of Aspects 1 to 11, the bent fastening portion 76 is bent from the distal end side of the extending portion 73 to be parallel to the opposing surface.

Accordingly, the other sheet metal such as the first sheet metal 71 is fastened to the bent fastening portion 76 in a posture parallel to the one sheet metal such as the second sheet metal 72. Accordingly, inclination of the gear held by the one sheet metal with respect to the gear held by the other sheet metal can be suppressed, and degradation of meshing between the gears can be suppressed.

### Aspect 13

According to Aspect 13, a sheet conveying device such as the sheet feeding apparatus 200 includes: a conveyor such as a conveying roller that conveys the sheet 14; and a drive apparatus that drives the conveyor, the drive apparatus being the drive apparatus of any one of Aspects 1 to 12.

Accordingly, since degradation of meshing of the gears of the drive apparatus is suppressed, sheet conveyance can be performed with low noise. Further, it is possible to suppress a decrease in transmission accuracy to convey the sheet 14 with high accuracy.

### Aspect 14

According to Aspect 14, the image forming apparatus 1 includes: a rotating body; and a drive apparatus that drives the rotating body, the drive apparatus being the drive apparatus of any one of Aspects 1 to 12.

Accordingly, since degradation of meshing of the gears of the drive apparatus is suppressed, image formation can be performed with low noise. Further, a decrease in transmission accuracy can be suppressed, the rotating body can be rotated with high accuracy, and a high-quality image without color shift or the like can be formed.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A drive apparatus, comprising:
a first sheet metal and a second sheet metal facing each other; and
a plurality of gears disposed between the first sheet metal and the second sheet metal,
the second sheet metal including
an opposing surface facing the first sheet metal,
an extending portion extending from the opposing surface toward the first sheet metal, and
a bent fastening portion at a distal end of the extending portion, the bent fastening portion fastened with a screw to a surface of the first sheet metal, and
a width dimension of the distal end of the extending portion being shorter than a maximum outer diameter of the screw fastening the bent fastening portion and the first sheet metal.

2. The drive apparatus according to claim 1, wherein:
the plurality of gears includes a first gear held by the second sheet metal and a second gear that meshes with the first gear held by the second sheet metal, and
the second gear is held by the first sheet metal.

3. The drive apparatus according to claim 1, wherein:
the plurality of gears includes at least one gear on a rotary shaft rotatably held by one of the first sheet metal and the second sheet metal.

4. The drive apparatus according to claim 3, wherein:
the rotary shaft is a motor shaft of a motor.

5. The drive apparatus according to claim 3, wherein:
a gear of the rotary shaft is non-removable from the rotary shaft or is molded with the rotary shaft.

6. The drive apparatus according to claim 1, wherein:
at least one of the plurality of gears is rotatably supported on a fixed shaft that is non-rotatably held by one of the first sheet metal and the second sheet metal.

7. The drive apparatus according to claim 1, further comprising three fastening portions, including the bent fastening portion, that fasten the first sheet metal and the second sheet metal.

8. The drive apparatus according to claim 1, further comprising a plurality of fastening portions, including the bent fastening portion, that fasten the first sheet metal and the second sheet metal,
wherein at least one of the plurality of fastening portions is a shaft that includes a female thread at a distal end of the shaft and that extends in a direction in which the first sheet metal and the second sheet metal face each other.

9. The drive apparatus according to claim 8, wherein:
the shaft rotatably supports a gear of the plurality of gears.

10. The drive apparatus according to claim 1, wherein:
the bent fastening portion is bent from the distal end of the extending portion to be parallel to the opposing surface.

11. The drive apparatus according to claim 1, wherein:
the bent fastening portion has a line-symmetrical shape with respect to a reference line passing through a center of a female thread of the bent fastening portion.

12. The drive apparatus according to claim 1, wherein:
at least one of the first sheet metal or the second sheet metal holds gears.

13. A sheet conveying device, comprising:
a conveyor to convey a sheet; and
the drive apparatus according to claim 1 to drive the conveyor.

14. An image forming apparatus, comprising:
a rotating body; and
the drive apparatus according to claim 1 to drive the rotating body.
